(19) United States
(12) Patent Application Publication
(10) Pub. No.: US 2026/0163312 A1
(43) Pub. Date: Jun. 11, 2026

(54) RETAINER CLIP, RETAINER CLIP ASSEMBLY, AND POWER METER MOUNTING SYSTEM FOR TOOL-FREE PANEL ATTACHMENT

(71) Applicant: Accuenergy (Canada) Inc., Toronto (CA)

(72) Inventors: Yufan Wang, Toronto (CA); Ketao Li, Toronto (CA); Liang Wang, Toronto (CA)

(73) Assignee: Accuenergy (Canada) Inc., Toronto (CA)

(21) Appl. No.: 18/976,431

(22) Filed: Dec. 11, 2024

(51) Int. Cl. H01R 13/74; F16B 2/20

(52) U.S. Cl. CPC H01R 13/743; F16B 2/20

(57) ABSTRACT

The invention relates to a retainer clip, a retainer clip assembly, and a power meter mounting system for securely attaching a power meter to a panel. The retainer clip includes a main body with primary arms for panel engagement, secondary arms with release tabs having sawtooth-shaped protrusions for locking into corresponding indentations on a base, and guide tabs for alignment within guiding channels on the base. An arc-shaped protrusion on the retainer clip facilitates tool-free installation and positioning. The assembly incorporates a base with U-shaped channels, sawtooth-shaped indentations, a central slider tab, and directional pins to constrain the clip's movement along a predefined linear path. The system integrates the retainer clip assembly with a power meter, secured via a snap-fit mechanism, enabling robust, tool-free installation and removal through multi-point anchoring. This design ensures precise alignment, structural stability, and ease of operation for industrial and commercial applications.

### FIELD OF THE INVENTION

The present invention relates to the field of power meter mounting systems, and more particularly, to retainer clips, retainer clip assemblies, and mounting systems designed for securely attaching power meters to panels.

### BACKGROUND

In various industries, power meters are widely used to measure and monitor electrical energy consumption. These devices are often mounted onto panels in industrial and commercial environments where secure and stable attachment is critical. Traditional mounting solutions typically rely on fasteners, adhesives, or other complex mechanisms that require tools and additional assembly steps, leading to inefficiencies during installation, maintenance, and replacement. Moreover, these conventional approaches often lack precise alignment features, resulting in improper installation, reduced reliability, and potential operational issues.

To address these challenges, tool-free mounting systems have gained attention as an efficient and reliable alternative. Such systems aim to simplify installation and removal processes while ensuring secure and precise attachment. However, existing tool-free systems often lack features that provide both secure retention and ease of alignment during installation, which may result in instability or damage to the components during operation.

Given the need for efficient and reliable mounting solutions in industrial and commercial environments, there is a need for a tool-free mounting system that ensures secure attachment of power meters to panels while providing precise alignment, ease of installation, and protection against operational stresses.

### SUMMARY OF THE INVENTION

The present invention provides a novel retainer clip, a retainer clip assembly, and a power meter mounting system designed to securely attach a power meter to a panel with enhanced precision, stability, and ease of installation. The retainer clip comprises a main body with a top portion, a bottom portion, and opposing sides. Primary arms extend outward and upward from the top portion, terminating in engagement ends configured to secure against the panel surface. Secondary arms extend downward and outward from the bottom portion, each equipped with release tabs featuring sawtooth-shaped protrusions that engage with corresponding indentations on a base. Guide tabs positioned on the opposing sides ensure precise alignment within guiding channels on the base. An arc-shaped protrusion extending from the bottom portion facilitates manual operation for tool-free installation.

The retainer clip further includes specific features to enhance functionality. The primary arms form an approximate angle of 150 degrees, creating a broad configuration for stable engagement. An arc-shaped curve at the top of the main body incorporates a peak point to limit upward movement, preventing excessive deformation. Release tabs include motion-limiting tabs that interact with openings on the base to prevent over-pressing during disengagement. A groove on the rear surface of the main body engages with a slider tab on the base, constraining movement to a linear path.

The retainer clip assembly incorporates a base with two side walls, each featuring U-shaped or partial U-shaped channels to guide the retainer clip's movement. Sawtooth-shaped indentations on the inner surfaces of the side walls engage with the clip's protrusions to create a unidirectional locking mechanism. Directional pins positioned on the base constrain the clip's motion along a predefined linear path. The base also includes a centrally positioned slider tab, elongate openings for motion-limiting tabs, and snap-fit connectors for attachment to the power meter.

The power meter mounting system integrates the retainer clip and assembly, securing the power meter to the panel through a snap-fit mechanism. The system provides tool-free installation and removal, ensuring stability and reliability through features such as multi-point anchoring, directional pin guidance, and sawtooth engagement. This innovative design addresses the need for efficient, secure, and durable mounting solutions in industrial and commercial applications.

### BRIEF DESCRIPTION OF THE DRAWINGS

FIG. 1 is a front, top, left perspective view of a mounting system in which a power meter is secured to a panel using a retainer clip assembly, including a retainer clip and a base attached to the power meter, according to some embodiments of the invention.

FIG. 2 is a right view of the mounting system, showing a power meter mounted on a panel with a retainer clip assembly that includes a retainer clip, and a base attached to the power meter, according to some embodiments of the invention.

FIG. 3 is a front view of the retainer clip according to some embodiments of the invention.

FIG. 4 is a rear view of the retainer clip according to some embodiments of the invention.

FIG. 5 is a front bottom right perspective view of the retainer clip according to some embodiments of the invention.

FIG. 6 is a rear bottom right perspective view of the retainer clip according to some embodiments of the invention.

FIG. 7 is a front view of the base according to some embodiments of the invention.

FIG. 8 is a rear view of the base according to some embodiments of the invention.

FIG. 9 is a front bottom left perspective view of the base according to some embodiments of the invention.

FIG. 10 is a rear bottom left perspective view of the base according to some embodiments of the invention.

FIG. 11 is a front view of the retainer clip assembly, illustrating its configuration in the engagement state, where the retainer clip is partially engaged with the base.

FIG. 12 is a rear view of the retainer clip assembly, illustrating its configuration in the engagement state, where the retainer clip is partially engaged with the base.

FIG. 13 is a front right perspective view of the retainer clip assembly, illustrating its configuration in the engagement state, where the retainer clip is partially engaged with the base.

FIG. 14 is a rear right view of the retainer clip assembly, illustrating its configuration in the engagement state, where the retainer clip is partially engaged with the base.

FIG. 15 is a front view of the retainer clip assembly, illustrating its configuration in the intermediate state, where the retainer clip is in the process of being moved toward its final position.

FIG. 16 is a front view of the retainer clip assembly, illustrating its configuration in the locked state, where the retainer clip is fully installed and securely positioned in its final configuration.

### DETAILED DESCRIPTION

The following description should be read with reference to the drawings, in which like elements in different drawings are numbered in like fashion. The drawings, which are not necessarily to scale, depict selected embodiments and are not intended to limit the scope of the invention. Although examples of construction, dimension, and materials are illustrated for the various elements, those skilled in the art will recognize that many of the examples provided have suitable alternatives that may be utilized.

Herein the terms “up,” “down,” “right,” and “left” are relative terms used to describe the orientation or direction of components, primarily for the ease of understanding the invention. They serve as spatial references to facilitate the description and are generally defined in relation to the figures presented in the drawings. It's essential to note that these terms are not intended to limit the invention to any specific orientation or spatial configuration unless explicitly stated.

In most cases, the use of these terms is standardized to match the orientation as presented in the drawings accompanying the patent application. However, the terms are relative to the “viewer” or the point of view in the drawings, and not necessarily indicative of a fixed spatial orientation in real-world use of the invention.

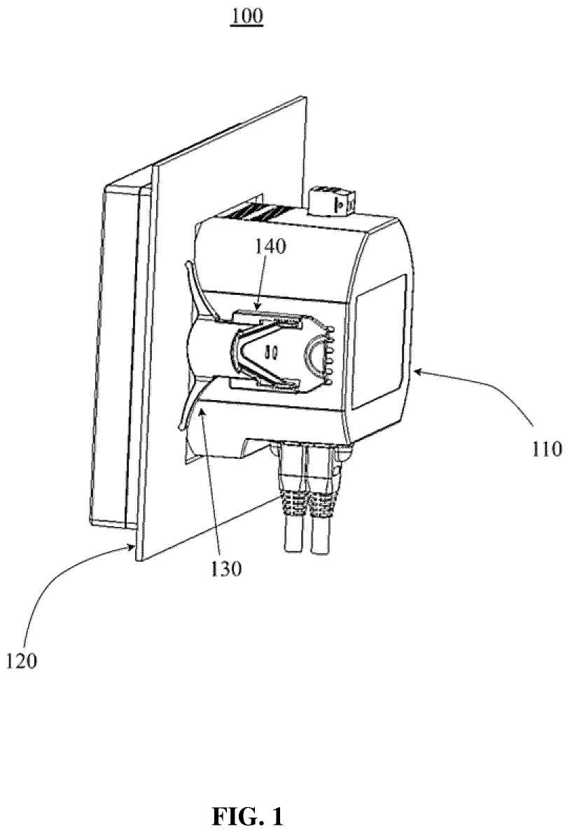

In FIG. 1, a power meter 110 is shown mounted on a panel 120 through a retainer clip assembly, which includes a primary retainer clip 130 and an associated base 140. The base 140 is securely attached to the left side portion of the power meter 110 and provides a guide or track along which the retainer clip 130 can slide. This sliding mechanism allows the retainer clip 130 to move towards or away from the panel 120 along the track, enabling secure positioning and adjustment for varying panel thicknesses. The configuration of the base 140 and the retainer clip 130 is designed to maintain a stable attachment, even in environments subject to vibration or movement, which is critical in industrial and commercial applications.

The retainer clip 130 is structured to exert lateral pressure against the surface of the panel 120. When the power meter 110 is inserted into the panel 120, the retainer clip 130 is actuated along the track to securely press against the panel, locking the power meter 110 in place. This design negates the need for additional fasteners or tools, as the retainer clip 130 relies on friction and pressure to achieve a secure mount. The base 140 is made from a resilient, durable material that supports repeated engagement and disengagement without degradation, ensuring long-term reliability.

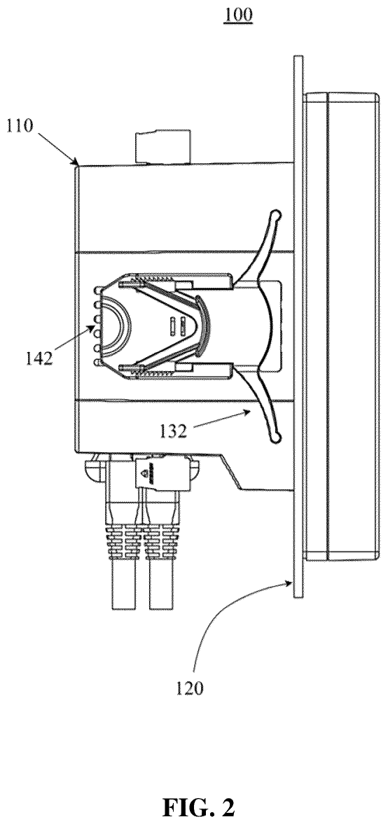

In FIG. 2, an alternate view of the power meter 110 is depicted, featuring an additional base 142 and a secondary retainer clip 132. The second retainer clip 132 is configured similarly to the first retainer clip 130 but is positioned on an opposite or adjacent side of the power meter 110, enhancing stability by providing balanced lateral pressure from multiple directions. The combination of retainer clips 130 and 132 and bases 140 and 142 enables the power meter 110 to be mounted to the panel 120 in a manner that distributes holding force evenly, thereby minimizing the risk of tilting or dislodging.

The retainer clips 130 and 132 are further equipped with manual release tabs that facilitate easy removal of the power meter 110 from the panel 120. When maintenance or replacement is required, an operator can press these tabs to disengage the clips, allowing the power meter 110 to be pulled free without the need for any tools. This tool-free engagement and disengagement mechanism reduces installation time and effort, particularly in high-density installations where access to the rear of the panel is limited.

Each retainer clip 130, 132 is composed of a high-strength material with elasticity, allowing it to apply consistent lateral pressure over repeated installations. The track mechanism within each base 140, 142 includes stops or detents that define the limits of movement for the retainer clips, ensuring that the clips maintain proper alignment with the panel 120 while preventing accidental overextension or disengagement.

The design also accommodates slight misalignments in the panel cutout, as the retainer clips 130 and 132 can adapt to various panel thicknesses and minor variations in positioning. The flexibility provided by the track mechanism and the material properties of the clips enhances the versatility of the power meter 110 mounting system, making it suitable for a wide range of applications and installation environments.

Through the combined use of bases 140, 142 and retainer clips 130, 132, the mounting system 100 described herein allows for reliable, tool-free installation of the power meter 110 onto the panel 120. This design not only simplifies the installation and maintenance processes but also ensures that the power meter 110 remains securely affixed in environments subject to operational stress. The retainer clip assembly, thus, provides an efficient, robust, and adaptable solution for mounting power meters in various industrial and commercial settings.

It should be understood that retainer clip 130 and retainer clip 132 have identical structures, as do base 140 and base 142. Therefore, the detailed description provided herein for retainer clip 132 and base 142 applies equally to retainer clip 130 and base 140 for those skilled in the art. Accordingly, any references to the structure, functionality, or features of retainer clip 132 and base 142 should be construed to also encompass retainer clip 130 and base 140, without the need for further repetition.

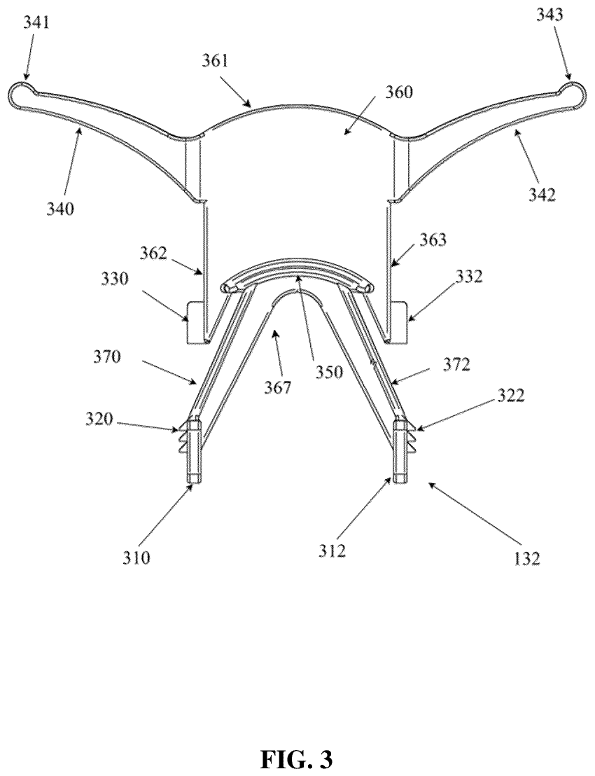

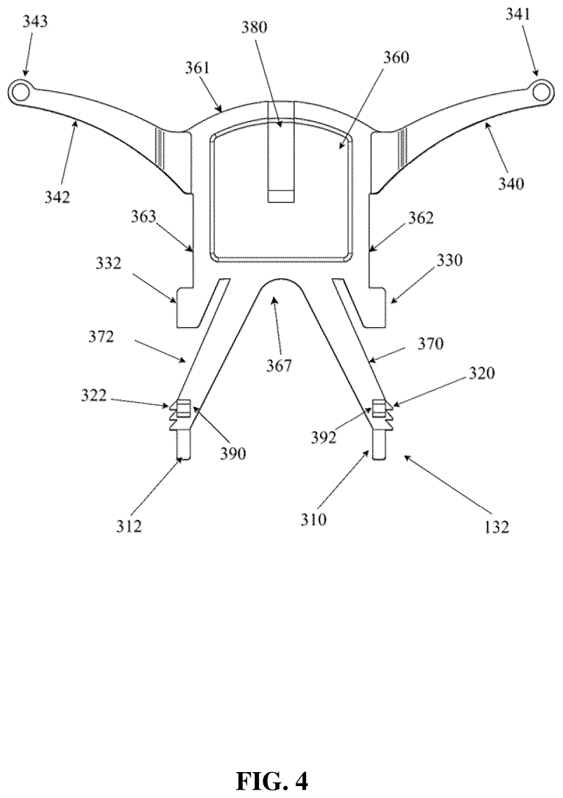

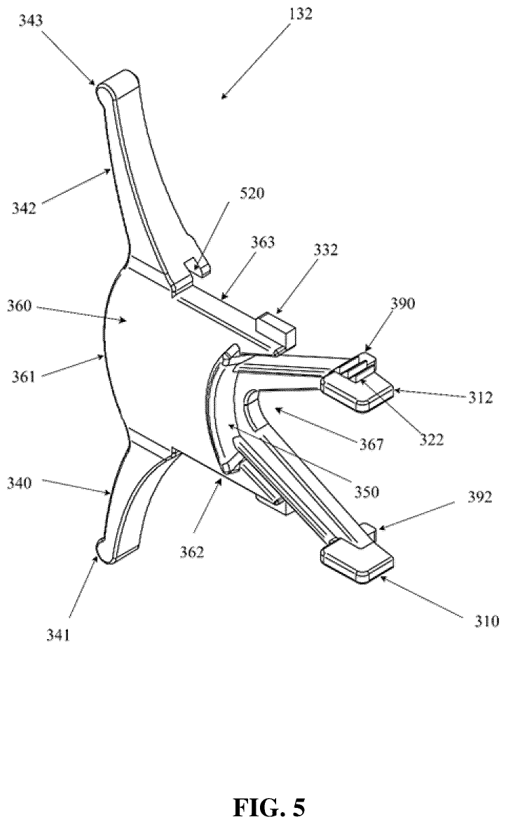

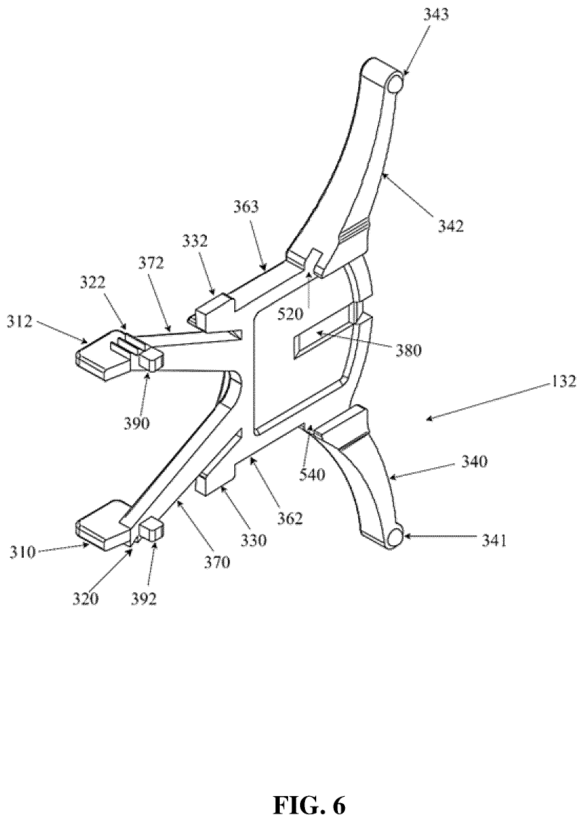

FIG. 3 illustrates a front view of the retainer clip 132 in accordance with some embodiments of the invention, providing a detailed depiction of the arrangement of the main body, arms, and associated components from a frontal perspective. FIG. 4 illustrates a rear view of the retainer clip 132, showcasing the structural features on the back side, including the positioning and configuration of the arms and related elements. FIG. 5 illustrates a front bottom right perspective view of the retainer clip 132, offering a three-dimensional representation that highlights the spatial arrangement of the main body, arms, and secondary support structures. FIG. 6 illustrates a rear bottom right perspective view of the retainer clip 132, providing a three-dimensional depiction of the rear side, emphasizing the configuration of the secondary arms and other supporting features. Collectively, these figures provide a comprehensive understanding of the retainer clip 132, and those skilled in the art will appreciate the full scope of its design and functionality by considering all four figures together.

In FIG. 3, the retainer clip 132 includes a main body 360 with two primary arms 340 and 342 positioned at the top of the main body 360. Arm 340 extends from the uppermost left side of the main body 360, angling outward and upward, while arm 342 extends from the uppermost right side of the main body 360, also angling outward and upward. These arms 340, 342 form an approximate angle of 150 degrees relative to each other, creating a broad, open configuration that allows the ends 341 and 343 of these arms to engage securely with the surfaces of the panel upon installation, providing stable anchorage for the power meter 110. The retainer clip 132 is designed to be left and right symmetric, ensuring balanced engagement and uniform functionality.

The main body 360 is a rectangular cube with a distinct shape profile. The top face of the main body features an arc-shaped curve 361 along its upper edge, creating a rounded boundary. Extending downward from each end of this arc are two parallel, vertical lines 362 and 363, defining the vertical sides of the main body. At the bottom face, the shape tapers inward, forming a trapezoidal recess 367 that points toward the center, resulting in an angled notch along the lower edge.

Below the main body 360, a forked structure is attached to its central bottom section, comprising two secondary support arms, 370 and 372. Arm 370 extends downward and outward toward the left side, passing through and extending out of the trapezoidal recess 367, beyond the extension line of the vertical side 362. Similarly, arm 372 extends downward and outward toward the right side, also emerging from the trapezoidal recess 367 and positioned to extend beyond the extension of vertical side 363. These arms are arranged at an acute angle relative to each other, converging inwardly to form a supportive, fork-like configuration. This specific arrangement of arms 370 and 372 enhances the structural stability of the retainer clip, providing resistance to lateral displacement and ensuring the clip remains securely anchored on the base.

The retainer clip 132 is further equipped with release tabs 310 and 312 at the lower termini of arms 370 and 372, respectively. These tabs allow a technician to disengage the clip from the base easily. Each release tab is outfitted with a series of sawtooth-shaped protrusions (320 and 322) on its outer surface, which interact with corresponding sawtooth-shaped indentations on the base. This sawtooth configuration enables unidirectional movement, allowing the retainer clip to slide forward along the base but preventing backward movement, thus creating a one-way locking mechanism that keeps the clip securely in place once installed.

An arc-shaped protrusion 350 extends outward from the central bottom section of the main body 360. This protrusion serves as a manual contact point, allowing the technician to press or push the retainer clip into a locked position during installation. By applying force to the arc-shaped protrusion 350, the technician can slide the clip along the base until the ends (341 and 343) of arms 340 and 342 engage securely with the surface of the panel, thereby securing the assembly in place.

Additionally, guide tabs (330 and 332) are positioned adjacent to the secondary arms (370 and 372) on the lower part of the main body (360). Guide tab 330 is located on the lower left side of the main body 360, adjacent to secondary arm 370, and extends outward from this section of the main body. Similarly, guide tab 332 is situated on the lower right side of the main body 360, adjacent to secondary arm 372, and also extends outward from the main body. These tabs 330 and 332 are designed to engage with an inner channel provided by a U-shaped guide on the base, ensuring precise alignment and controlled linear movement of the retainer clip during installation and removal. This configuration stabilizes the retainer clip, allowing for secure attachment to the panel and facilitating easy disengagement when necessary.

In FIG. 4, which provides a rear view of the retainer clip 132, a groove 380 is depicted on the back of the main body 360. The groove 380 originates from the topmost central portion of the main body 360 and extends downward toward the center of the main body 360, following the direction of side 363. The groove 380 is configured to engage with a slider tab 750 fixed on the base 142, thereby restricting the movement of the retainer clip 132 to a controlled path. Specifically, this configuration limits the motion of the retainer clip 132 to a direction parallel to side 363, which corresponds to a linear path toward or away from the panel 120, ensuring precise alignment and secure engagement during operation.

A motion-limiting tab 390 is shown on the release tab 312. The motion-limiting tab 390 is configured to engage with a corresponding opening in the base 142, preventing excessive pressing of the release tab 312 during the disengagement of the retainer clip 132 from the base 142. This feature safeguards the structural integrity of the fork structure, including arms 370 and 372, which could otherwise be damaged if the release tabs 312 and 310 are pressed excessively toward each other. Similarly, a motion-limiting tab 392 is positioned on the release tab 310. The motion-limiting tab 392 operates in conjunction with another opening in the base 142 to prevent over-pressing of the release tab 310, ensuring reliable operation and preventing damage to the retainer clip 132 during disengagement.

In FIG. 5, a sliding recess structure 520 is depicted on the arm 342, positioned near the junction between the arm 342 and the side 363 of the main body 360. The sliding recess structure 520 is formed as a concave feature with smooth interior surfaces to ensure low-friction interaction with the directional pin 747 located on the base 142. The recess is shaped to securely accommodate the directional pin 747, preventing lateral displacement and enabling precise alignment of the retainer clip 132 during movement.

The sliding recess structure 520 is designed with dimensional tolerances that allow the retainer clip 132 to move smoothly along a linear path while maintaining stable engagement with the base 142. This configuration constrains the movement of the retainer clip 132 exclusively to the direction of side 363, ensuring a controlled and guided motion toward or away from the panel 120. The recess's depth and curvature are optimized to provide consistent contact with the directional pin 747, preventing misalignment or unintended detachment during operation.

Similarly, an identical sliding recess structure 540 (shown in FIG. 6) is present on the opposite arm 341, positioned near the junction between the arm 340 and the side 362 of the main body 360. Sliding recess 540 provides the same functionality as sliding recess 520, engaging with the corresponding directional pin 737 on the base 142. Together, the sliding recess structures 520 and 540, in conjunction with the directional pins 747 and 737, ensure symmetrical, consistent, and controlled movement of the retainer clip 132 along the predefined path. This dual-recess design enhances the overall stability and precision of the retainer clip assembly during installation and operation.

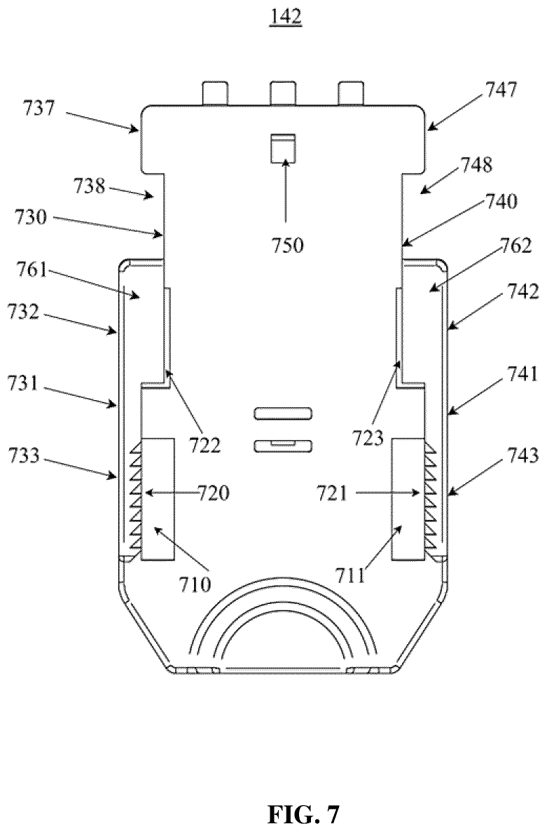

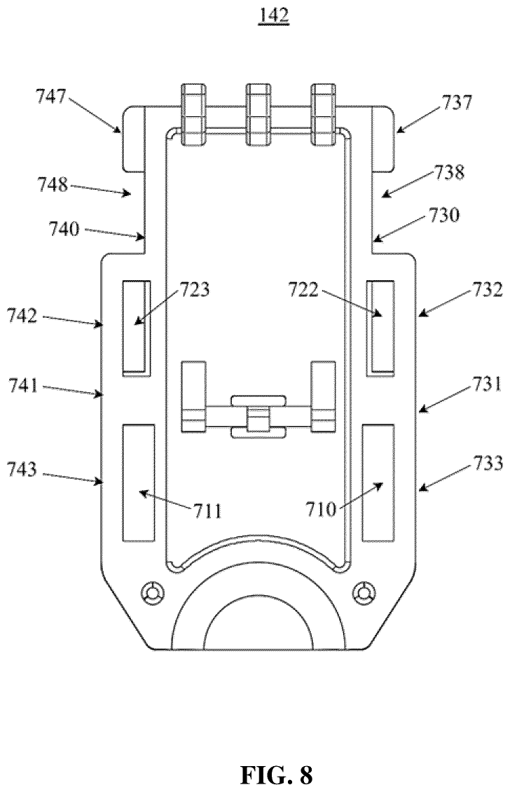

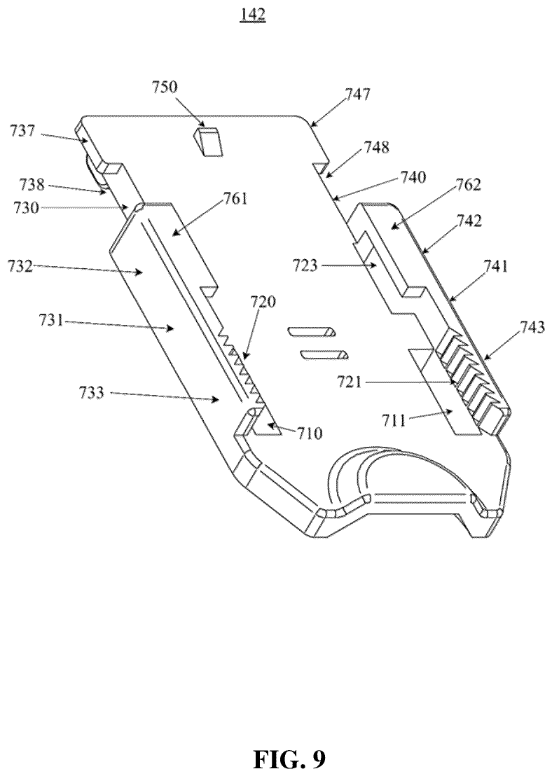

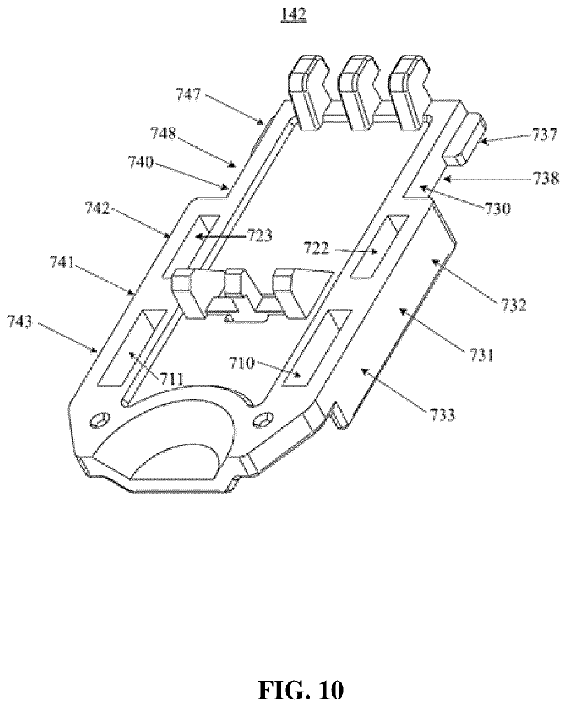

FIGS. 7 through 10 collectively illustrate various views of the base 142 according to some embodiments of the invention, providing a comprehensive understanding of its design and functionality. FIG. 7 presents a front view, while FIG. 8 shows a rear view, highlighting structural details visible from each perspective. FIG. 9 offers a front bottom left perspective view, and FIG. 10 depicts a rear bottom left perspective view, both emphasizing the spatial arrangement of the base's features. Together, these figures enable those skilled in the art to fully appreciate the scope of the base's configuration and its intended operational characteristics.

Base 142 is a structural component configured to securely engage with a retainer clip 132 and facilitate its linear movement during the installation and removal process. The base 142 is a generally flat, elongated structure with a rectangular profile, featuring a series of specifically designed features to guide, align, and lock the retainer clip in place.

In FIG. 7 and FIG. 9, the base 142 is symmetrically designed, with two side walls 731 and 741 positioned along the left and right edges of the base, respectively.

The left side wall 731 is not only raised above the surface of the base 142 but also extends outward beyond it, forming an elevated and outward-projecting structure along the left side 730 of the base 142. The bottom half of the left side wall 731 includes sawtooth-shaped indentations 720 that run longitudinally along its inner surface. These indentations are configured to engage with corresponding sawtooth-shaped protrusions on the retainer clip 132, thereby creating a unidirectional locking mechanism. This mechanism permits forward movement of the retainer clip along the base while preventing backward displacement, ensuring secure retention during operation.

Above the sawtooth-shaped indentations 720, the left side wall 731 transitions into a partial U-shaped channel 732 that extend upward and outward along the inner surface of the wall. The channel 732 is specifically designed to accommodate and guide the guide tab 330 of the retainer clip 132, facilitating precise alignment and stable linear movement along the base.

The partial U-shaped channel 732 comprises a longitudinal cavity formed by a single vertical wall 761 and a recessed base section, with an opening 722 on the opposite side where the second vertical wall would typically be located. This structure creates a partial U-shaped channel with one side unobstructed. The vertical wall 761 extends upward from the recessed base section, providing lateral support and alignment for a corresponding component, such as a sliding or fitting element. The recessed base section serves as the foundation of the channel, offering structural support and a low-friction surface to facilitate smooth movement or secure placement of the guided component.

Similarly, the right-side wall 741 mirrors the design of the left side wall and is also raised above and extends outward beyond the surface of the base 142, forming an elevated and outward-projecting structure along the right side 740. The bottom half of the right-side wall 741 incorporates sawtooth-shaped indentations 721 that run longitudinally along its inner surface. Like the left side wall, these indentations interact with the corresponding sawtooth-shaped protrusions on the retainer clip, providing the same unidirectional locking functionality to allow forward movement and prevent backward displacement.

Above the sawtooth-shaped indentations 721, the right-side wall 741 transitions into a partial U-shaped channel 742, extending upward and outward along the inner surface. The channel 742 is configured to guide the guide tab 332 of the retainer clip, ensuring precise alignment and smooth movement along the base.

The partial U-shaped channel 742 comprises a longitudinal cavity formed by a single vertical wall 762 and a recessed base section, with an opening 723 on the opposite side where the second vertical wall would typically be located.

By raising and extending beyond the surface of the base, both side walls 731 and 741 enhance the structural functionality of the base 142. This design provides a dedicated and reinforced pathway for the guiding and locking mechanisms, ensuring smooth operation, secure engagement, and reliable retention of the retainer clip during installation and operation.

In FIG. 7 and FIG. 9, a slider tab 750 is positioned at the top and central part of base 142. The slider tab 750 is configured to engage with a corresponding groove 380 located on the central back of the retainer clip 132. This engagement serves to restrict the movement of the retainer clip 132 to a predefined, controlled path, ensuring precise alignment and guided motion during operation. The interaction between the slider tab 750 and the groove 380 prevents lateral displacement and facilitates smooth linear movement along the intended axis.

In FIG. 7 and FIG. 9, base 142 includes two directional pins 737 and 747, positioned symmetrically on the uppermost left and right corners of the base. The directional pin 737 is located at the topmost left corner of base 142 and is formed as a rectangular block that projects outwardly from the left side 730. Similarly, the directional pin 747 is positioned at the topmost right corner of the base 142 and is also formed as a rectangular block projecting outwardly from the right side 740.

The directional pin 737 interacts with a sliding recess structure 540 located near the junction between arm 342 and side 363 of the main body 360 of the retainer clip 132. This interaction constrains the movement of the retainer clip 132 along a predefined linear path by aligning and guiding it during installation and operation. The pin-recess configuration prevents lateral or undesired rotational displacement, ensuring precise alignment and stability of the retainer clip throughout its motion.

Similarly, the directional pin 747 is configured to engage with a sliding recess structure 520 located near the junction between arm 340 and side 362 of the main body 360 of the retainer clip 132. This engagement mirrors the functionality of the pin-recess interaction on the left side, maintaining symmetry in the movement constraints and ensuring that the retainer clip follows a predetermined path without deviation.

These directional pins 737 and 747 and their corresponding sliding recess structures 540 and 520 collectively define the motion constraints of the retainer clip 132, ensuring that its movement is restricted to a linear direction aligned with the guiding channels of the base 142. This design prevents misalignment and facilitates smooth and controlled operation, enabling secure and reliable engagement of the retainer clip with the base.

In FIG. 7 and FIG. 9, a recess 738 is defined by the directional pin 737, the left side 730, and the U-shaped channel 732 on the base 142. This recess 738 is precisely dimensioned to accommodate the sliding recess structure 540 of the retainer clip 132 when the clip is in the engagement state during installation. The engagement state refers to a condition where the retainer clip 132 has partially interacted with the base 142 but has not yet been fully secured. In this state, the sliding recess structure 540 fits snugly within the recess 738, providing preliminary alignment and stability for the retainer clip. Additional details and illustrations of the engagement state will be explained in subsequent drawings.

Similarly, a recess 748 is defined by the directional pin 747, the right side 740, and the U-shaped channel 742. This recess 748 is also precisely configured to perfectly accommodate the sliding recess structure 520 of the retainer clip 132 when the clip is in the engagement state during installation. This symmetric arrangement ensures that both sliding recess structures 540 and 520 are securely aligned within their respective recesses 738 and 748, maintaining balance and stability during the initial stages of installation.

These recesses 738 and 748 play a critical role in the controlled engagement of the retainer clip 132 with the base 142, ensuring precise alignment and preventing lateral displacement during installation. By securely housing the sliding recess structures 540 and 520 in the engagement state, the recesses facilitate smooth transition toward the fully secured state, enhancing the overall reliability and ease of the installation process.

An elongate opening 710 is located on the surface of base 142, positioned below the sawtooth-shaped indentations 720. This opening 710 is specifically configured to provide a clearance space for the motion-limiting tab 392 during the installation of the retainer clip 132. The upward movement of the motion-limiting tab 392 into this opening ensures smooth engagement of the retainer clip with the base. Additionally, the elongate opening 710 prevents excessive pressing of the release tab 310 during disengagement, thereby protecting the structural integrity of the retainer clip and ensuring reliable operation.

Similarly, an elongate opening 711 is located on the surface of base 142, positioned below the sawtooth-shaped indentations 721. This opening 711 functions in a similar manner, providing a clearance space for the motion-limiting tab 390 during the installation process. The upward movement of the motion-limiting tab 390 into this space ensures proper alignment and engagement of the retainer clip 132. During disengagement, the elongate opening 711 also prevents excessive pressing of the release tab 312, thereby maintaining the durability and functionality of the assembly.

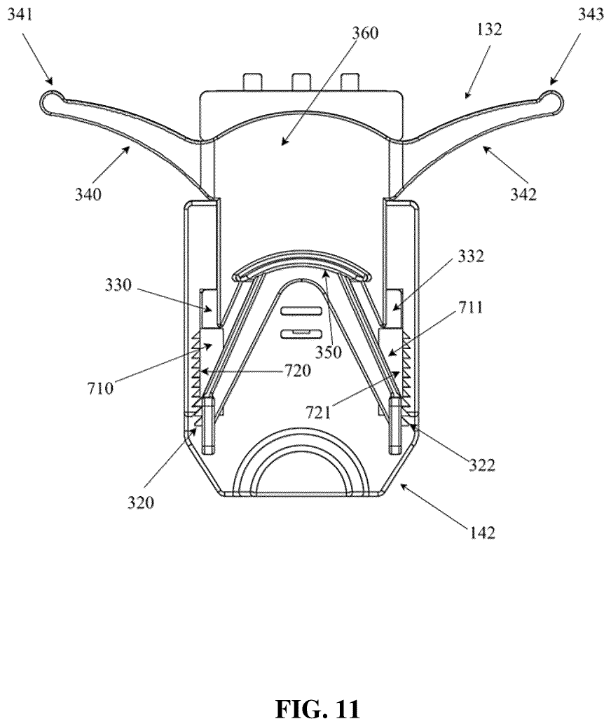

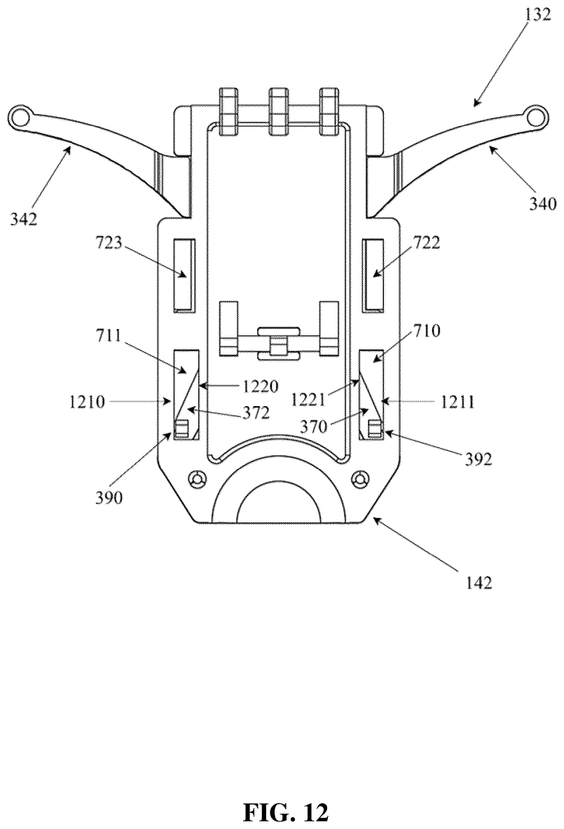

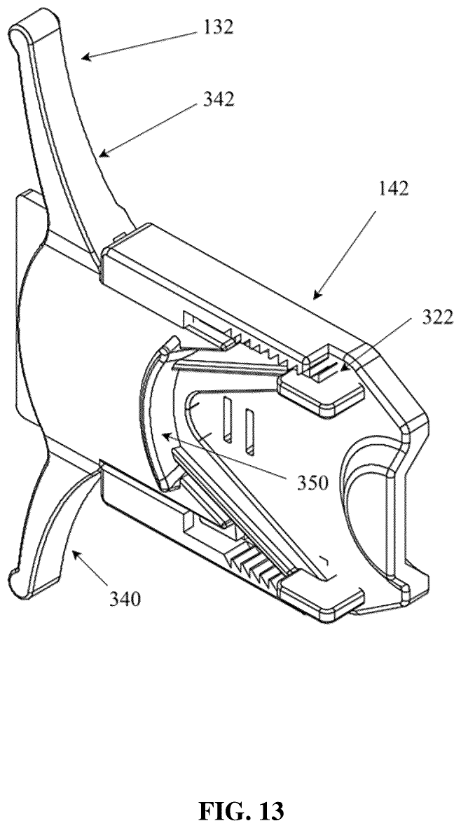

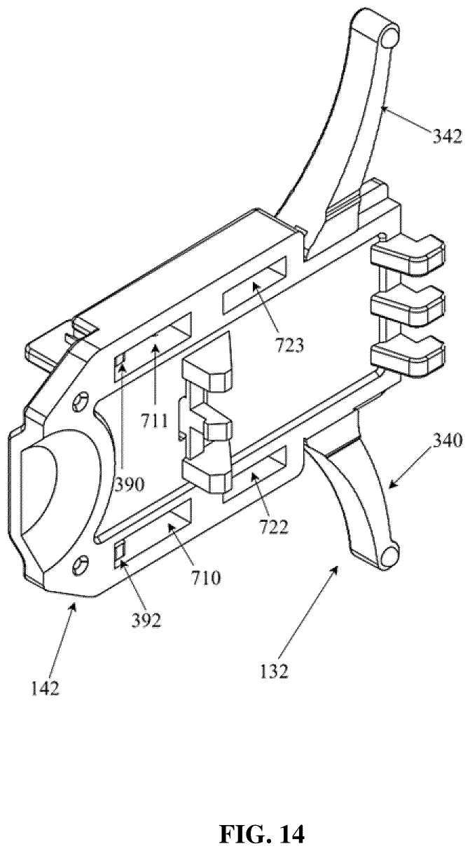

FIGS. 11 through 14 collectively illustrate various views of the retainer clip assembly in the engagement state, where the retainer clip is partially engaged with the base. FIG. 11 provides a front view, while FIG. 12 depicts a rear view, highlighting the alignment and positioning of the retainer clip during this intermediate stage of installation. FIG. 13 presents a front right perspective view, and FIG. 14 offers a rear right perspective view, both emphasizing the spatial arrangement and interaction between the retainer clip and the base. Together, these figures enable those skilled in the art to fully appreciate the design, functionality, and configuration of the retainer clip assembly in the engagement state.

In the engagement state depicted in FIG. 11 and FIG. 13, one of the sawtooth-shaped protrusions 320 on the release tab engages with a corresponding sawtooth-shaped indentation 720 on the base, while the remaining sawtooth-shaped protrusions 320 remain outside the sawtooth-shaped indentations 720. Similarly, one of the sawtooth-shaped protrusions 322 engages with a corresponding sawtooth-shaped indentation 721, while the other sawtooth-shaped protrusions 322 remain disengaged from the sawtooth-shaped indentations 721. This configuration represents the partial engagement characteristic of the engagement state, ensuring alignment and preliminary retention of the retainer clip with the base.

In the engagement state depicted in FIG. 11, the guide tab 330 is positioned on the surface of base 142 between the opening 710 and the opening 722, while the guide tab 332 is positioned on the surface of base 142 between the opening 711 and the opening 723. When the technician applies upward force to the arc-shaped protrusion 350, the retainer clip 132 moves closer to the panel 120. During this movement, the guide tab 330 transitions into the partial U-shaped channel 732, and the guide tab 332 transitions into the partial U-shaped channel 742. This guided motion ensures precise alignment and stability as the retainer clip approaches its secure position on the panel.

In the engagement state depicted in FIG. 12, the motion-limiting tab 390 engages with the left side 1210 of the opening 711. Opening 711 is defined by two opposing sides: the left side 1210, which is positioned farther from the center of the base (142), and the right side 1220, which is positioned closer to the center of base 142. Similarly, the motion-limiting tab 392 engages with the right side 1211 of the opening 710. Opening 710 is also defined by two opposing sides: the right side 1211, which is positioned farther from the center of the base 142, and the left side 1221, which is positioned closer to the center of the base 142. This arrangement ensures precise alignment and controlled interaction between the motion-limiting tabs and their respective openings during the engagement state.

To disengage the retainer clip 132 from base 142, the technician must press the release tab 310 and release tab 312 toward each other. As force is exerted, the motion-limiting tab 390 transitions from engaging with the left side 1210 of the opening 711 to engaging with the right side 1220, while the motion-limiting tab 392 transitions from engaging with the right side 1211 of the opening 710 to engaging with the left side 1221. This controlled movement is guided by the opposing sides of the openings, and the blocking action of the right side 1220 and left side 1221 prevents the technician from exerting excessive force on the release tabs 310 and 312. This design safeguards the integrity of the fork structure, including arms 370 and 372, by mitigating the risk of damage due to overexertion during the disengagement process.

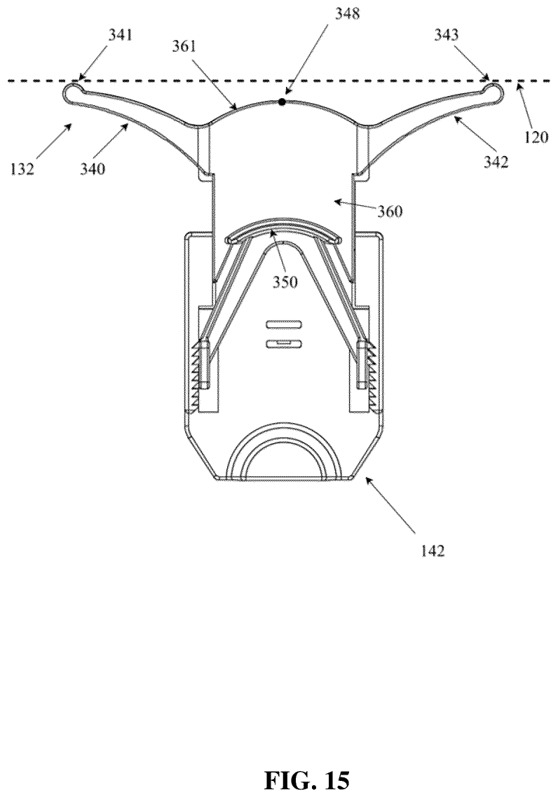

FIG. 15 is a front view of the retainer clip assembly, illustrating its configuration in the intermediate state, where the retainer clip is in the process of being moved toward its final position.

When the technician applies upward pressure to the arc-shaped protrusion 350 while the assembly is in the engagement state, the assembly transitions into the intermediate state, as depicted in FIG. 15. In this state, the ends 341 and 343 of the retainer clip 132 begin to make contact with the surface of panel 120, initiating the process of secure engagement. However, the peak point 348 of the arc-shaped curve 361, which is the closest point to the panel 120 among all points on the curve 361, has not yet come into contact with the panel 120. This configuration represents a critical transitional phase, ensuring alignment and positioning of the retainer clip relative to the panel before it reaches its fully secured position in the locked state.

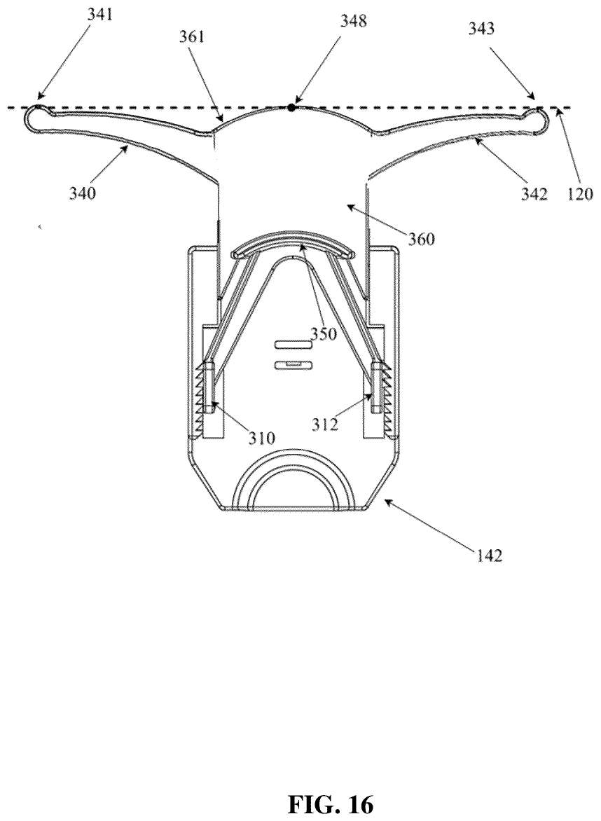

FIG. 16 is a front view of the retainer clip assembly, illustrating its configuration in the locked state, where the retainer clip is fully installed and securely positioned in its final configuration.

When the technician pushes the arc-shaped protrusion 350 upward while the assembly is in the intermediate state, the assembly transitions into the locked state as shown in FIG. 16. In this state, ends 341 and 343 are fully engaged with the surface of the panel 120, securing the retainer clip in place. Additionally, the peak point 348 of the arc-shaped curve 361 comes into contact with the surface of the panel 120. This contact at the peak point 348 prevents further upward movement of the retainer clip 132, protecting the structural integrity of the assembly by avoiding excessive deformation or damage to the arms 340 and 342.

In the locked state, these three engagement points, end 341 and 343, along with the peak point 348, provide a secure and stable fixation of the power meter 110 to the panel 120. This configuration ensures a reliable and robust connection, maintaining the assembly's durability under operational conditions.

When the assembly is in the locked state, as shown in FIG. 16, pressing the release tabs 310 and 312 toward each other transitions the assembly into the release state. In the release state, the technician can easily move the retainer clip 132 downward along the base 142. This downward movement disengages the retainer clip 132 from the base 142, allowing the retainer clip to be removed smoothly and without excessive force. This configuration facilitates efficient disassembly, ensuring that the retainer clip 132 can be detached from base 142 with minimal effort while preserving the structural integrity of the assembly components.

Base 142 is secured to the power meter 110 using a snap-fit mechanism. The snap-fit connection allows base 142 to be fixed to the power meter 110 without the need for additional fasteners or adhesives, providing a reliable and efficient attachment method. This snap-fit mechanism is a commonly known prior art technique and is not the focus of this invention. Its inclusion here serves to facilitate the integration of base 142 with the power meter 110, enabling the functionality of the inventive retainer clip assembly described herein.

Embodiments of the teachings of the present disclosure have been described in an illustrative manner. It is to be understood that the terminology that has been used, is intended to be in the nature of words of description rather than of limitation. Many modifications and variations of the embodiments are possible in light of the above teachings. Therefore, within the scope of the appended claims, the embodiments can be practiced other than specifically described.

What is claimed is:

1. A retainer clip for securing a power meter to a panel, comprising:
a main body having a top portion, a bottom portion, and opposing sides;
a pair of primary arms extending outward and upward from the top portion of the main body, each arm terminating in an engagement end configured to contact and secure against a surface of the panel;
a pair of secondary arms extending downward and outward from the bottom portion of the main body, each secondary arm including a release tab having sawtooth-shaped protrusions on its outer surface, the sawtooth-shaped protrusions being configured to engage with corresponding sawtooth-shaped indentations on a base;
guide tabs positioned on the opposing sides of the main body, adjacent to the secondary arms, and configured to engage with guiding channels on the base to provide precise alignment and controlled movement of the retainer clip; and
an arc-shaped protrusion extending outward from the bottom portion of the main body, the arc-shaped protrusion being configured to receive a manual force to facilitate the installation and secure positioning of the retainer clip.

2. The retainer clip of claim 1, wherein the primary arms form an angle of approximately 150 degrees relative to each other, creating a broad, open configuration for stable engagement with the panel.

3. The retainer clip of claim 1, wherein the top portion of the main body includes an arc-shaped curve having a peak point, the peak point being configured to contact the surface of the panel during installation to limit upward movement of the retainer clip, thereby preventing excessive deformation or structural stress on the primary arms.

4. The retainer clip of claim 1, wherein the release tabs are equipped with motion-limiting tabs configured to interact with openings on the base to prevent over-pressing of the release tabs during disengagement.

5. The retainer clip of claim 1, wherein the main body includes a groove on its rear surface, the groove being configured to engage with a slider tab on the base to restrict the retainer clip to linear movement.

6. The retainer clip of claim 1, wherein the secondary arms are arranged at an acute angle relative to each other, providing structural stability and resistance to lateral displacement during operation.

7. The retainer clip of claim 1, wherein the sawtooth-shaped protrusions on the release tabs are angled to allow forward movement along the sawtooth-shaped indentations on the base while preventing backward movement.

8. The retainer clip of claim 1, wherein the arc-shaped protrusion is centrally positioned on the bottom portion of the main body and is ergonomically designed to facilitate manual operation during installation.

9. A retainer clip assembly for mounting a power meter to a panel, comprising:
a base, including:
two side walls, each having a U-shaped channel configured to guide the movement of the retainer clip;
sawtooth-shaped indentations on the inner surfaces of the side walls, configured to engage with sawtooth-shaped protrusions on the retainer clip;
a centrally positioned slider tab, configured to engage with a groove on the retainer clip to align and constrain its motion; and
a pair of directional pins positioned on the base, configured to restrict the motion of the retainer clip to a predefined linear path; and
a retainer clip as defined in claim 1, operatively configured to engage with the base through interaction with the sawtooth-shaped protrusions, the indentations, the guide tabs, and the directional pins, thereby providing a secure and tool-free attachment of the power meter to the panel.

10. The retainer clip assembly of claim 9, wherein the U-shaped channel is a partial U-shaped channel, having one vertical wall and a recessed base, configured to guide the movement of the retainer clip.

11. The retainer clip assembly of claim 10, wherein the partial U-shaped channels on the side walls are configured to receive guide tabs of the retainer clip, ensuring precise alignment and smooth linear movement along the base.

12. The retainer clip assembly of claim 9, wherein the sawtooth-shaped indentations are angled to permit forward movement of the retainer clip along the base while preventing backward movement, providing a unidirectional locking mechanism.

13. The retainer clip assembly of claim 9, wherein the slider tab is formed as an elongate projection extending vertically from the surface of the base, the projection being dimensioned to fit within the groove of the retainer clip to prevent lateral displacement.

14. The retainer clip assembly of claim 9, wherein the directional pins are positioned at opposite ends of the base and are configured to engage with sliding recess structures on the retainer clip to constrain its movement along a linear axis.

15. The retainer clip assembly of claim 9, wherein the base further includes elongate openings positioned below the sawtooth-shaped indentations, the openings providing clearance for motion-limiting tabs on the retainer clip during installation and disengagement.

16. The retainer clip assembly of claim 9, wherein the base includes a central alignment groove extending longitudinally along its surface, configured to engage with a corresponding ridge on the retainer clip to enhance alignment during installation.

17. The retainer clip assembly of claim 9, wherein the base further includes snap-fit connectors or fastener holes, configured to securely mount the base to the power meter housing.

18. A power meter mounting system for securing a power meter to a panel, comprising:
a base as defined in claim 2, configured to be attached to the power meter via a snap-fit mechanism;
a retainer clip as defined in claim 1, configured to engage with the base and secure the power meter to the panel;
wherein the base and retainer clip assembly provide a tool-free installation and removal mechanism for the power meter, ensuring secure attachment to the panel through a combination of sawtooth engagement, directional pin guidance, and multi-point anchoring via the primary arms of the retainer clip.
